(19) United States
(12) Patent Application Publication
(10) Pub. No.: US 2007/0205385 A1
(43) Pub. Date: Sep. 6, 2007

(54) SLIDE VALVE FOR A COATING SYSTEM, AND A COATING SYSTEM

(75) Inventors: Jochen KRAUSE, Dresden (DE); Michael HOFMANN, Dresden (DE)

Correspondence Address: HESLIN ROTHENBERG FARLEY & MESITI PC, 5 COLUMBIA CIRCLE, ALBANY, NY, 12203, US

(73) Assignee: VON ARDENNE ANLAGENTECHNIK GMBH, Dresden (DE)

(21) Appl. No.: 11/676,693

(22) Filed: Feb. 20, 2007

(30) Foreign Application Priority Data
Feb. 21, 2006 (DE) 10 2006 008 354.7
Sep. 13, 2006 (DE) 10 2006 043 813.2

(51) Int. Cl. F16K 3/00; B65B 31/04; F16K 25/00

(52) U.S. Cl. 251/195; 141/66; 251/326; 414/217; 118/50; 118/715

(57) ABSTRACT

A slide valve, especially useful in a coating system for coating substrates in a vacuum, includes a housing formed from housing walls. An opening and a sealing surface surrounding the opening is provided in each of two opposing housing walls, with the openings forming a passage through the housing. At least one closing element with two sealing surfaces, is guided back and forth in a mobile manner crosswise to the passage in the housing between a rest position that releases the openings and a working position that completely overlaps the openings. An actuating force that acts on the closing element when the closing element moves into the working position applies a pressure to the sealing surfaces surrounding the openings of the housing walls, which pressure depends on the level of the actuating force. The coating system contains the slide valve.

### BACKGROUND ART

The invention relates to a slide valve, and a coating system.

Valves of this type are frequently installed in continuous coating systems used for coating laminar substrates such as plastic or glass plates, plastic foils, magnetic tapes or films etc. in a vacuum. Such continuous coating machines are often subdivided into sections which serve different purposes. The sections are arranged consecutively in the transportation direction of the substrate and are connected to each other via openings through which the substrate is led from one section to the next

It may be necessary to ventilate a section, e.g. in order to replace a sputter cathode or to carry out other maintenance work whilst the vacuum or working atmosphere should be maintained in the adjacent sections

For this reason, switchable sluice valves are provided between the individual sections. In this way, the volume to be vented again after a section has been ventilate is reduced considerably as only individual sections are ventilated and the other sections can remain in the evacuated state constantly. However, it is of course also possible to ventilate the entire system if necessary.

These valves therefore do not have to constantly switch back and forth but are only activated in the event of load changes or other system downtimes, although they must then seal the pressure differential between atmospheric pressure and vacuum.

DE 198 57 201 A1 discloses a flat sluice valve for simultaneous shutoff or release of two continuous openings provided between two vacuum chambers, which openings are aligned with each other, have a low height and a large width. The valve is designed for continuous systems for coating large plates of glass.

It has two opposing valve plates or slide plates for closing the openings. The slide plates form a structural unit which can be switched back and forth in a translational manner between a rest position in which the openings are free and a working position by means of a first actuating drive. In the working position, the slide plates lie between the openings and overlap them completely.

Between the two slide plates, which are elastically pressed against each other in the rest position and initially do not close the openings tightly even in the working position, a further short-stroke fluid (pneumatic) closing drive is arranged that is pressurised after the slide plates have been brought into their working position and that forces apart the two plates until, in their closing position, they simultaneously abut sealing surfaces surrounding the openings and assigned to each of them, and thus close the openings tightly. The reaction forces of the closing drive are discharged via the opposing valve plate.

To open this valve, pressurisation of the actuating drive is discontinued; it is also possible to apply a vacuum to the actuating drive in the reverse direction in order to support the elastic forces that have a restoring effect on the slide plates. In this known valve, elastic sealing rings are inserted into grooves of the slide plates.

U.S. Pat. No. 4,157,169 discloses another sluice valve that is in principle very similar to the one described above and is provided to open and close two circular continuous openings. Instead of flexible sealing rings, valve seats in the form of soft metal supports are provided on the edges of the openings, to which sealing rings, also made from soft metal, arranged on the slide plates, correspond.

In the two solutions, the fluid closing drive of the slide plates and hence also its supply lines must also be moved back and forth in the changeovers between the rest and working positions. Consequently, the mobile slide parts are relatively complicated and costly.

DE 44 46 946 C1 describes a further similar slide valve with a valve disc, in the form of a simple plate, which valve disc can be switched from a rest position to a working position. This document does not say anything about the sealing pressure of the valve disc against its valve seat or about the design of the seals used. Furthermore, this slide valve only has one effective direction, as a valve seat is only provided on one side of the slide plate.

A slide valve is known from DE 20 2004 005 217 U1 in which a simple plate located in a housing is brought from a rest position to its working position in front of the opening to be closed, preferably by means of any power-operated actuating drive. To close the opening, the plate is pushed towards a housing wall on which the corresponding sealing surface is located by means of a closing drive attached to the housing. The closing motion of this valve and its slide plate is angular, preferably at a right angle to the actuation between the rest position and working position of its slide plate.

In one embodiment, the slide valve is assembled mirror-symmetrical with two closing drives and two sealing surfaces so that it can assume two different closing positions. In this way, depending on the direction of the pressure differential which arises, the slide valve can always be closed selectively via the slide plate in such a way that the greater pressure on one side amplifies the sealing effect even further.

### SUMMARY OF THE INVENTION

On the basis of this state of the art, one aspect of this invention is to provide a slide valve which, with the simplest possible design, enables secure sealing between two sections, even in the event of very high pressure differentials. A further aspect of the invention is to provide a coating system subdivided into sections, in which system reliable sealing between adjacent sections can be attained in a simple manner.

The slide valve according to the invention has a housing formed from housing walls, with an opening and a sealing surface surrounding the opening being provided in two opposing housing walls and with the openings forming a passage through the housing. In addition, at least one closing element with two sealing surfaces is provided, which closing element is guided back and forth in a mobile manner crosswise to the passage in the housing between a rest position that releases the openings and a working position that overlaps the openings completely. The slide valve according to the invention is characterised in that an actuating force that acts on the closing element when the closing element moves into the working position applies a pressure to the sealing surfaces surrounding the openings in the housing walls, which pressure depends on the level of the actuating force.

A major advantage of the inventive solution is that reliable separation of adjacent process areas can be achieved easily by bringing the closing element from the rest position to the working position, as known from the state of the art using an actuating drive for example, and applying to it an actuating force that acts in the motion direction of the closing element. There is no need here for additional means to generate a force acting crosswise to the motion direction of the closing element (achieved by means of closing drives in the state of the art). This makes the slide valve less expensive and simpler in design than known slide valves, and this in turn makes it less susceptible to faults.

Diverse embodiments are feasible for the slide valve according to the invention. For example, it would be possible to provide a lever mechanism that converts a force acting in the motion direction of the closing element in such a way that at least one component of this force acts crosswise to the motion direction of the closing element.

In a particularly elegant, simple and inexpensive embodiment of the invention, provision is made for at least one sealing surface of the closing element as well as the corresponding sealing surface of an opening of the housing to be inclined in the motion direction of the closing element. By means of this design, the actuating force acting in the motion direction of the closing element is separated into two components, one of which components exerts pressure on the sealing surfaces surrounding the openings. At the same time, a sealing effect is created on both sides if and as long as the two sealing surfaces of the closing element do not run parallel to each other.

For this embodiment, it is essentially sufficient if one of the two sealing surfaces of the closing element and housing wall is inclined in the motion direction of the closing element. To achieve the desired effect, the other sealing surface of the closing element and housing wall could thus run parallel to the motion direction of the closing element. However, the wedge shape of the closing element would ensure secure sealing on both sides. Even so, lateral misalignment of the closing element would remain possible due to the sliding on the inclined sealing surface.

In an advantageous further embodiment, provision is therefore made for both sealing surfaces of the closing element and the sealing surfaces of both openings of the housing to be inclined in the motion direction of the closing element. In this process, both sealing surfaces of the closing element and the sealing surfaces of both openings of the housing preferably enclose the same inclination angle with the motion direction of the closing element.

Accordingly, the cross-section of the closing element could advantageously have the shape of an isosceles triangle or trapezium. When choosing the inclination angle, it must be borne in mind that very small inclination angles can cause jamming of the closing element, thus making it harder for the slide valve to open. By contrast, the force required for sealing increases as the inclination angle gets larger. A person skilled in the art will have no difficulty in calculating a suitable inclination angle by means of simple experiments if necessary and thus solving the potential conflict described above.

In order to improve the sealing effect, an additional sealant can be provided in at least one sealing surface of the closing element and/or at least one sealing surface surrounding an opening. This sealant is preferably a mastic sealing strip inserted into a groove.

In order to prevent the closing element from jamming in the closing position due to the sliding on the inclined sealing surface, provision can be made for the closing element to be suspended in an oscillating manner to compensate for lateral misalignment caused by the sliding. This is useful particularly, but only, if the corresponding sealing surfaces of the closing element and housing wall are only inclined in the motion direction of the closing element on one side.

In order to incorporate the slide valve into the operating control unit, for example of a coating system, the slide valve according to the invention can additionally be provided with at least one closing drive for moving the closing element between the rest position and the working position. The closing drive can advantageously comprise an electric motor and/or a spindle drive and/or a pneumatic cylinder and/or other intrinsically known drive elements.

In order to achieve a good sealing effect, the roughness and positional accuracy of the sealing surface surrounding the opening must meet high requirements. For this reason, and in order to save material, in one embodiment of the invention provision is made for the area of the housing wall containing the opening and the sealing surface to be designed as a separate component which can be detachably connected to the housing. The detachable connection of this component to the housing wall can advantageously be carried out by means of screws.

According to a further embodiment of the invention, the housing wall containing the opening has a mounting means for detachably fixing other components. This mounting means can be screws, for example. In conjunction with the embodiment of the area of the housing wall which contains the opening as a separate component, it is possible to simultaneously use screws that provide the detachable connection of the separate component with the housing wall to attach additional components. Examples of additional components include panels or consoles for supporting additional components of a coating system such as covers.

The coating system according to the invention for coating substrates in a vacuum, which system comprises at least two adjacent sections that can be separated from each other in a vacuum-tight manner by means of a shut-off valve, is characterised in that the shut-off valve is a slide valve according to the invention with the characteristics described above that is arranged between the sections in such a way that the passage formed by the openings in the housing of the slide valve allows transportation of a substrate through the housing of the slide valve.

In one embodiment of the invention, the housing of the slide valve is non-detachably connected to the housing of the coating system and has an opening to the atmosphere so that the closing element can be removed without opening the coating system. The housing forms an inversion of the housing of the coating system. The closing element and a closing drive that may provided can be replaced or maintained without having to open the coating system itself. Provision is advantageously made for the housing of the slide valve to be a component of a dividing wall arranged between two sections of the coating system.

According to a further embodiment of the invention, the housing of the slide valve is detachably connected to the housing of the coating system so that the slide valve can be fully removed from the coating system. This embodiment makes it possible to replace the slide valve in fall, for instance with a slide valve with bigger or smaller openings, if another substrate size is to be processed.

In addition, in the coating system according to the invention, provision can be made for a cover that extends in the transportation direction of the substrates between a dividing wall of the coating system and a housing wall of the slide valve in at least one section. This allows a closed lining of the section to be created that allows a higher gas separation value and defined pump access conditions to adjacent sections.

Furthermore, provision can be made for a console to be arranged on at least one housing wall of the slide valve containing an opening. This console can be used to support the cover on sides of the housing wall of the slide valve.

As an alternative or as an addition, provision can be made for a panel to be arranged on at least one housing wall of slide valve containing an opening. Such panels are frequently used to protect coating system components from being coated inadvertently or being attacked by acid.

In the coating system according to the invention, provision can also be made for a transport device for transporting the substrates through the coating system to be provided in a transport plane, and for the slide valve to be arranged in such a way that the passage defined by the openings of the housing of the slide valve is located in the transport plane. In this way, substrates placed on the transport device are conveyed through the passage of the slide valve when the slide valve is opened. If the slide valve is closed, the adjacent sections are thus separated from each other by a vacuum. The transport system can, for example, consist of a plurality of rollers onto which the substrate is laid, and the slide valve can be arranged between the last roller of a first section and the first roller of a second section.

### BRIEF DESCRIPTION OF THE DRAWING FIGURES

The invention is described in greater detail below on the basis of an execution example and an associated figure.

FIG. 1 shows a longitudinal section of a coating system according to the invention with a slide valve according to the invention;

FIG. 2 shows an enlarged detailed view of the slide valve in the coating system according to FIG. 1.

### DETAILED DESCRIPTION

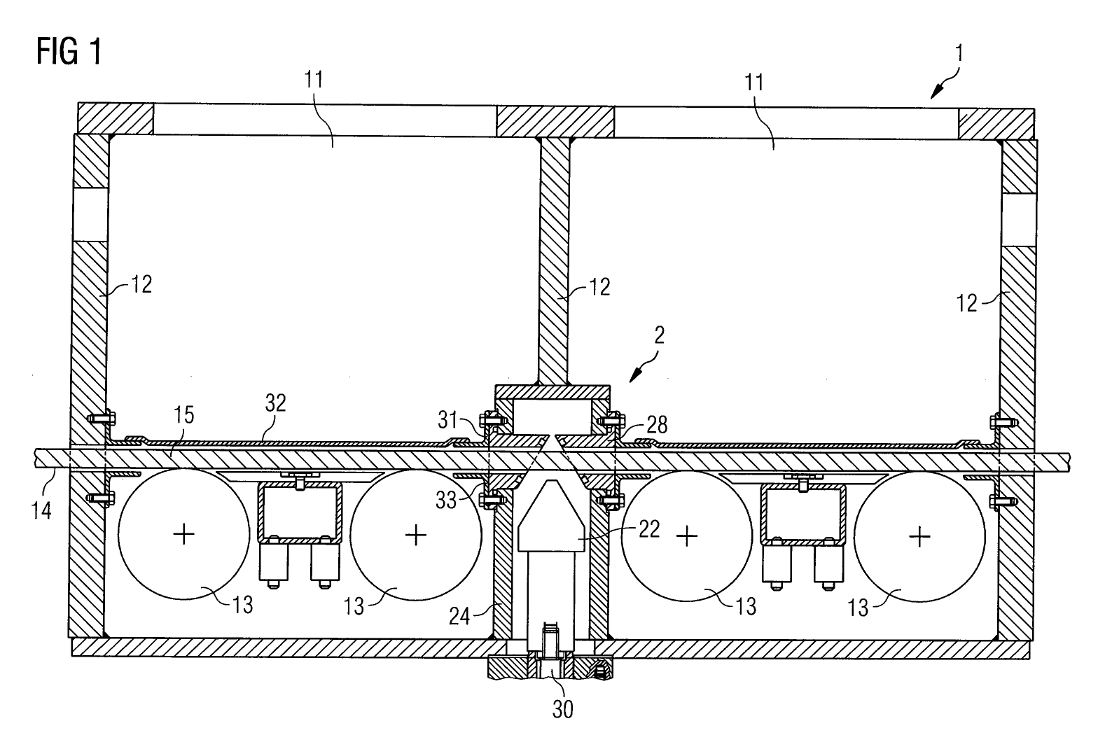

FIG. 1 shows a longitudinal section of two adjacent sections (11) of a coating system (1) which comprises several sections (11) for coating substrates (15) in a vacuum. The sections (11) can be separated from each other in a vacuum-tight manner by means of a shut-off valve (2) arranged between them. The shut-off valve (2) is a slide valve whose characteristics are described in more detail below. It is arranged between the sections (11) in such a way that the passage formed by the openings (25) in the housing of the slide valve (2) allows transportation of a substrate (15) through the housing of the slide valve (2).

The housing of the slide valve (2) is non-detachably connected with the housing of the coating system (1) and has an opening (21) to the atmosphere so that the closing element (22) can be removed without opening the coating system (1). The housing of the slide valve (2) is a component of a dividing wall (12) arranged between two sections (11) of the coating system (1).

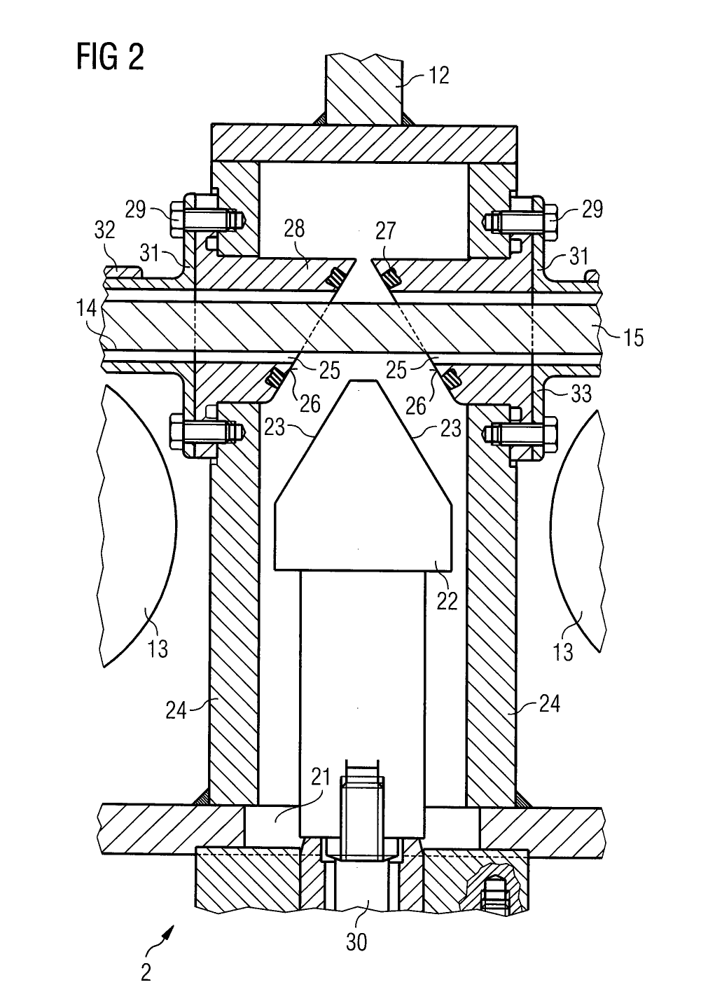

The slide valve (2) shown in FIG. 2 consists of a housing formed from housing walls (24). In each of two opposing housing walls (24), an opening (25) and a sealing surface (26) surrounding the opening (25) are provided. The openings (25) form a passage through the housing. A closing element (22) with two sealing surfaces (23) is arranged in the housing. The closing element (22) is guided in the housing in such a way that it can move back and forth crosswise to the passage between a rest position that releases the openings (25) and a working position that completely overlaps the openings (25).

An actuating force that acts on the closing element (22) when the closing element (22) moves into the working position in the direction of motion applies a pressure to the sealing surfaces (26) surrounding the openings (25) of the housing wall (24), which pressure depends on the level of the actuating force. This is attained in that both sealing surfaces (23) of the closing element (22) and the sealing surfaces (26) of both openings (25) of the housing are inclined in the motion direction of the closing element (22). Both sealing surfaces (23) of the closing element (22) and the corresponding sealing surfaces (26) of both openings (25) of the housing enclose the same inclination angle with the motion direction of the closing element (22). This inclination angle is selected from the range between 0° and 90° in such a way that secure sealing is attained with reasonable expenditure of force without causing the closing element (22) to jam between the sealing surfaces (26) of the housing.

A transport device for transporting the substrates (15) through the coating system (1) in a transport plane (14) is provided in each section (11). The transport device comprises several rollers (13) onto which the substrate (15) is placed. The top of the rollers (13) defines the transport plane (14). The slide valve (2) is arranged between the last roller (13) of the first section (11) and the first roller (13) of the second section (11) in such a way that the passage defined by the openings (25) of the housing of the slide valve (2) is located in the transport plane (14).

That area of the two housing walls (24) which contains the opening (25) and the sealing surface (26) surrounding the opening (25) is designed as a separate component (28) which can be detachably connected to the housing, the detachable connection being established by means of screws (29). The screws (29) are simultaneously used to detachably fix a panel (33) on each housing wall (24) of the slide valve (2).

A cover (32) which extends in the transportation direction of the substrates (15) between a dividing wall (12) of the coating system (1) and a housing wall (24) of the slide valve (2) is provided in each of the two illustrated sections (11) of the coating system (1). On sides of the slide valve (2), the cover (32) rests on a console (31) which is also detachably fixed on a housing wall (24) of the slide valve (2) with the screws (29).

The two sealing surfaces (26) which surround the openings (25) of the housing of the slide valve (2) each have an additional sealant (27) that, in the execution example, is a mastic sealing strip inserted into a groove.

In order to activate the slide valve (2), a closing drive (30) that interacts with the closing element (22) is provided outside the coating system (1) in order to move the closing element (22) between the rest position and the working position, said closing drive (30) comprising an electric motor and a spindle drive.

1. Slide valve, especially for vacuum-tight separation of two consecutive sections of a coating system, comprising a housing formed from housing walls, two opposed housing walls having openings surrounded by sealing surfaces, with the openings forming a passage through the housing, and at least one closing element that has two sealing surfaces and is guided back and forth in a mobile manner crosswise to the passage between a rest position that releases the openings and a working position that completely overlaps the openings, wherein an actuating force which acts on the closing element when the closing element moves into the working position applies a pressure to the sealing surfaces surrounding the openings of the housing walls, which pressure depends on the level of the actuating force.

2. Slide valve according to claim 1, wherein at least one sealing surface of the closing element as well as a corresponding sealing surface surrounding an opening in a corresponding one of the opposed housing walls are inclined in a motion direction of the closing element.

3. Slide valve according to claim 1, wherein both sealing surfaces of the closing element and the sealing surfaces of both openings of the opposed housing walls are inclined in a motion direction of the closing element.

4. Slide valve according to claim 3, wherein both sealing surfaces of the closing element and the sealing surfaces of both openings of the opposed housing walls enclose a same inclination angle with the motion direction of the closing element.

5. Slide valve according to claim 1, wherein an additional sealant is provided in at least one sealing surface of the closing element.

6. Slide valve according to claim 1, wherein an additional sealant is provided in at least one sealing surface surrounding one of said openings.

7. Slide valve according to claim 6, wherein the sealant is a mastic sealing strip inserted into a groove.

8. Slide valve according to claim 1, wherein the closing element is suspended in an oscillating manner in order to compensate for lateral misalignment.

9. Slide valve according to claim 1, further comprising at least one closing drive for moving the closing element between the rest position and the working position.

10. Slide valve according to claim 9, wherein the closing drive comprises an electric motor.

11. Slide valve according to claim 9, wherein the closing drive comprises a spindle drive.

12. Slide valve according to claim 9, wherein the closing drive comprises a pneumatic cylinder.

13. Slide valve according to claim 1, wherein an area of an opposed housing wall which area contains an opening of said openings and a sealing surface surrounding the opening comprises a separate component which can be detachably connected to the housing.

14. Slide valve according to claim 13, wherein the separate component is connected to the housing by screws.

15. Slide valve according to claim 1, wherein at least one of the opposed housing walls has a mounting means for detachably fixing other components.

16. Slide valve according to claim 15, wherein the mounting means comprise screws.

17. Coating system for coating substrates in a vacuum, comprising at least two adjacent sections which can be separated from each other in a vacuum-tight manner by means of a shut-off valve, wherein the shut-off valve comprises a slide valve according to claim 1 and is arranged between the sections in such a way that the passage of the slide valve allows transportation of a substrate through the housing of the slide valve.

18. Coating system according to claim 17, wherein the housing of the slide valve is non-detachably connected to a housing of the coating system and has an opening to the atmosphere so that the closing element can be removed without opening the coating system.

19. Coating system according to claim 18, wherein the housing of the slide valve is a component of a dividing wall arranged between two sections of the coating system.

20. Coating system according to claim 17, wherein the housing of the slide valve is detachably connected to a housing of the coating system so that the slide valve can be fully removed from the coating system.

21. Coating system according to claim 17, further comprising a cover which extends in a transportation direction of the substrate between a dividing wall of the coating system and a housing wall of the slide valve in at least one section of the coating system.

22. Coating system according to claims 21, wherein a console is arranged on at least one of the opposed housing walls of the slide valve.

23. Coating system according to claim 22, wherein the cover rests on the console.

24. Coating system according to claim 17, wherein a panel is arranged on at least one housing wall of the opposed housing walls of the slide valve.

25. Coating system according to claim 17, further comprising a transport device for transportation of substrates through the coating system in a transport plane, and wherein the slide valve is arranged in such a way that the passage defined by the openings of the slide valve is located in the transport plane.

26. Coating system according to claim 25, wherein the transport device comprises a plurality of rollers, and the slide valve is arranged between a last roller of a first section and a first roller of a second section.
